(19) United States
(12) Patent Application Publication
(10) Pub. No.: US 2021/0035034 A1
(43) Pub. Date: Feb. 4, 2021

(54) CROP CHARACTERISTIC PREDICTION SYSTEM, CROP CHARACTERISTIC PREDICTION METHOD, AND NON-TRANSITORY COMPUTER-READABLE STORAGE MEDIUM STORING CROP CHARACTERISTIC PREDICTION PROGRAM

(71) Applicant: Toyota Jidosha Kabushiki Kaisha, Toyota-shi Aichi-ken (JP)

(72) Inventors: Hiroyuki Enoki, Hamamatu-shi (JP); Kazuyo Suzuki, Toyota-shi (JP); Minoru Inamori, Kariya-shi (JP); Yu Kimura, Okazaki-shi (JP)

(21) Appl. No.: 16/940,846

(22) Filed: Jul. 28, 2020

(30) Foreign Application Priority Data
Aug. 2, 2019 (JP) 2019-142677

(51) Int. Cl. G06Q 10/04; A01B 79/00; G06F 9/30

(52) U.S. Cl. CPC G06Q 10/04; G06F 17/18; G06F 9/3001; A01B 79/005

(57) ABSTRACT

Prediction model area environment representative data that representatively indicates an environment of a prediction model area is generated based on prediction model area environmental data and prediction model area data. Additionally, prediction model area crop characteristic representative data that represents a characteristic of a crop cultivated in the prediction model area is generated. Based on the prediction model area environment representative data and the prediction model area crop characteristic representative data, a crop characteristic prediction model is generated. Crop characteristic prediction data that indicates a crop characteristic of a crop in the prediction target area is generated by applying the crop characteristic prediction model to prediction target area environment representative data that is generated based on prediction target area environmental data and prediction target area data relating to a land of the prediction target area to representatively indicate an environment of the prediction target area.

### CROSS REFERENCE TO RELATED APPLICATIONS

The present application claims priority from Japanese patent application JP 2019-142677 filed on Aug. 2, 2019, the entire content of which is hereby incorporated by reference into this application.

### BACKGROUND

### Technical Field

The present disclosure relates to a crop characteristic prediction system, a crop characteristic prediction method, and a non-transitory computer-readable storage medium storing a crop characteristic prediction program.

### Background Art

From the aspect of an increase in yields and profitability of farm products, a technique of obtaining characteristics of crops to be cultivated in advance is desired. The crop characteristics (such as a yield) vary according to varieties and cultivation methods and are especially susceptible to cultivation environments, such as weather and the nature of soil. Conventionally, development of a method of predicting the crop characteristics from environmental data, such as the weather, is attempted. However, when the number of pieces of the data of the characteristics and the environment is inappropriate, the prediction is low in accuracy and less likely to be practical.

Additionally, as techniques of predicting growth of the crops during the cultivation, for example, there are known techniques described in JP 2019-030253 A, JP 2019-000006 A, and JP 2018-088196 A. JP 2019-030253 A discloses a method of predicting growth timing by obtaining cultivation situation prediction data from environment measurement value data relating to the growing environment of a plant and growth examination value data relating to the growth situation of the plant and using them. Additionally, J P 2019-000006 A discloses a system that uses hydroponic pipes with a weight sensor included in a plant cultivation house. JP 2018-088196 A discloses a method of predicting a yield of a crop from image data captured with a preset.

However, with all the techniques disclosed in JP 2019-030253 A, JP 2019-000006 A, and JP 2018-088196 A, the crop needs to be actually cultivated to collect and analyze the crop characteristic data and the environmental data, and thus it requires cost, labor, and time. Additionally, the crop characteristics that can be predicted are limited to the characteristics examined relating to the crops that are actually cultivated.

### SUMMARY

The present disclosure provides a crop characteristic prediction system, a crop characteristic prediction method, and a crop characteristic prediction program that ensure collecting and analyzing characteristics including a yield of a target crop in advance at low cost without actually performing a cultivation test at an area where the crop is desired to be predicted.

To solve the above-described problem, a crop characteristic prediction system according to the present disclosure is configured as a computer system comprises a data input unit; a data storage unit; an arithmetic operation unit; a representative data generating unit that generates prediction model area environment representative data that representatively indicates an environment of a prediction model area as an area where data relating to an actually-cultivated crop is obtained based on prediction model area environmental data relating to the environment of the prediction model area and prediction model area data relating to a land of the prediction model area, and generates prediction model area crop characteristic representative data that represents a crop characteristic as a characteristic of a crop cultivated in the prediction model area; a crop characteristic prediction model generating unit that generates a crop characteristic prediction model based on the prediction model area environment representative data and the prediction model area crop characteristic representative data; and a crop characteristic prediction data generating unit that generates prediction target area environment representative data that representatively indicates an environment of a prediction target area as an area where a crop characteristic of a crop to be a target is desired to be predicted based on prediction target area environmental data relating to the environment of the prediction target area and prediction target area data relating to a land of the prediction target area, and generates crop characteristic prediction data that indicates a crop characteristic of a crop in the prediction target area by applying the crop characteristic prediction model to the prediction target area environment representative data.

Additionally, a crop characteristic prediction method according to the present disclosure uses a computer system including a data input unit, a data storage unit, and an arithmetic operation unit and comprises: generating prediction model area environment representative data that representatively indicates an environment of a prediction model area as an area where data relating to an actually-cultivated crop is obtained based on prediction model area environmental data relating to the environment of the prediction model area and prediction model area data relating to a land of the prediction model area; generating prediction model area crop characteristic representative data that represents a crop characteristic as a characteristic of a crop cultivated in the prediction model area; generating a crop characteristic prediction model based on the prediction model area environment representative data and the prediction model area crop characteristic representative data; generating prediction target area environment representative data that representatively indicates an environment of a prediction target area as an area where a crop characteristic of a crop to be a target is desired to be predicted based on prediction target area environmental data relating to the environment of the prediction target area and prediction target area data relating to a land of the prediction target area; and generating crop characteristic prediction data that indicates a crop characteristic of a crop in the prediction target area by applying the crop characteristic prediction model to the prediction target area environment representative data. Note that a crop characteristic prediction program that allows the same method to be executed on a computer is also provided.

The present disclosure can provide the crop characteristic prediction system, the crop characteristic prediction method, and the crop characteristic prediction program that ensure collecting and analyzing the crop characteristic in advance at low cost without actually performing a cultivation test. That is, based on the environment and the crop characteristic in the prediction model area, the crop characteristic prediction model is generated. The environment and the crop characteristic in the prediction model area are reflected in the crop characteristic prediction model. In view of this, the environment of the prediction target area is specified, and the crop characteristic prediction model is applied. Accordingly, the crop characteristic in the prediction target area can be predicted. In the prediction target area, the crop characteristic can be predicted without actually performing the cultivation test or the like.

### BRIEF DESCRIPTION OF THE DRAWINGS

FIG. 1 is a block diagram illustrating an overall configuration of a crop characteristic prediction system 1 according to an embodiment;

FIG. 2 is a flowchart describing an execution procedure of a crop characteristic prediction method executed in the system 1;

FIG. 3A is an example of data of a plurality of kinds of crops and cropping types and the number of pieces of the data that are selected as data in prediction model area crop characteristic representative data in a first region;

FIG. 3B is an example of data of a plurality of kinds of crops and cropping types and the number of pieces of the data that are selected as data in prediction model area crop characteristic representative data in a second region;

FIG. 4 indicates a procedure and a method of selecting prediction model representative data on a crop “buckwheat” in the first region;

FIG. 5 is a graph describing an effect by executing a selection of representative data (Step S13 in FIG. 2);

FIG. 6 is a graph describing an effect by executing a selection of representative data (Step S13 in FIG. 2);

FIG. 7 is a graph describing an effect by executing a selection of representative data (Step S13 in FIG. 2);

FIG. 8 is a graph describing an effect by executing a selection of representative data (Step S13 in FIG. 2);

FIG. 9 illustrates an example of soil area representative data;

FIG. 10 illustrates an example of weather area representative data;

FIG. 11 indicates an example of crop characteristic prediction data;

FIG. 12 is a conceptual diagram describing an exemplary evaluation method of a crop characteristic prediction model;

FIG. 13 is a graph describing the exemplary evaluation method of the crop characteristic prediction model;

FIG. 14 indicates a result of evaluating the crop characteristic prediction model for each of 55 kinds of crops and cropping types in the first region;

FIG. 15 indicates a result of evaluating the crop characteristic prediction model for each of 15 kinds of crops and cropping types in the second region;

FIG. 16 contrastingly indicates actual crop characteristic data and the crop characteristic prediction data in the first region obtained by the system according to the embodiment; and

FIG. 17 contrastingly indicates actual crop characteristic data and the crop characteristic prediction data in the second region obtained by the system according to the embodiment.

### DETAILED DESCRIPTION

The following describes embodiments with reference to the accompanying drawings. The accompanying drawings represent functionally same elements by same reference numerals in some cases. Although the accompanying drawings illustrate the embodiment and examples of implementation according to a principle of the present disclosure, these drawings are for understanding of the present disclosure and never used for limited interpretation of the present disclosure. The descriptions of this specification are merely typical examples and therefore do not limit the claims and application examples of the present disclosure by any means.

While the embodiment gives the description in detail enough for a person skilled in the art to carry out this disclosure, it is necessary to understand that other implementations and configurations are possible and changes in configurations and structures and substitutions of various components can be made without departing from the scope or spirit of the technical idea of this disclosure. Therefore, the following description should not be interpreted to be limited.

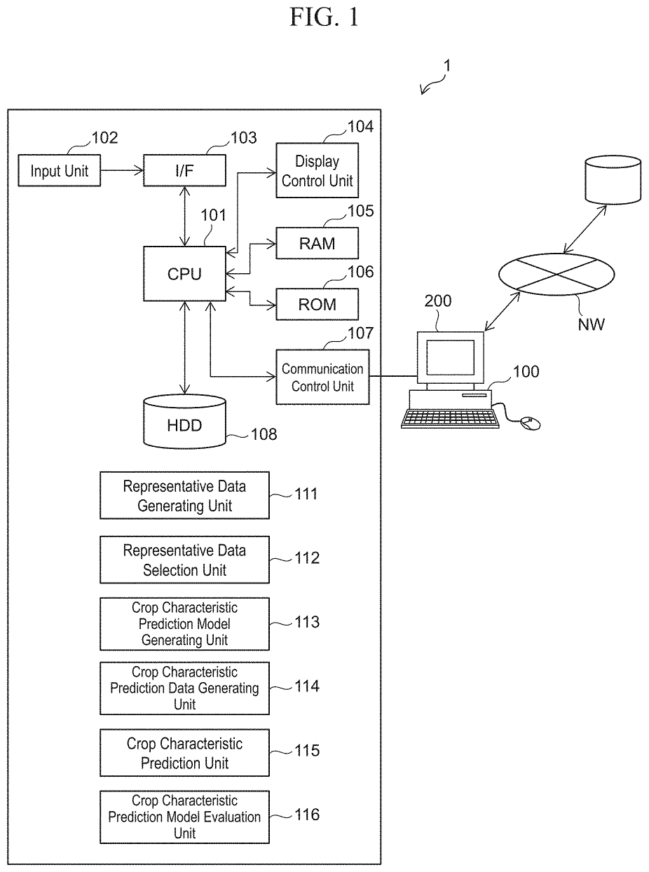

Next, a description will be given of a crop characteristic prediction system according to the embodiment with reference to FIG. 1 and the like.

FIG. 1 is a block diagram illustrating an overall configuration of a crop characteristic prediction system 1 according to the embodiment. This crop characteristic prediction system 1 includes a computer 100 that is accessible to agriculture-related big data via a network NW and a display 200. The computer 100 can predict what sort of characteristics are obtained relating to a certain crop in an area to be a prediction target based on the agriculture-related big data.

The computer 100 includes, as an example, a CPU 101, an input unit 102, an interface (I/F) 103, a display control unit 104, a RAM 105, a ROM 106, a communication control unit 107, and a hard disk drive (HDD) 108. The CPU 101 is an arithmetic control circuit that manages various kinds of arithmetic processing, controls, commands, and the like in the computer 100. The input unit 102 is a device, such as a keyboard, a computer mouse, a touchscreen, and the like, that accepts instructions and selections from a user. The display control unit 104 analyzes and calculates various data obtained via the network NW, and manages a control to display a crop characteristic prediction model, a crop characteristic prediction result, and the like on a display. The crop characteristic prediction model, the crop characteristic prediction result, and the like are obtained as a result of the analysis and the calculation.

The HDD 108 stores a computer program to execute a crop characteristic prediction process. This computer program specifies a procedure to virtually achieve a representative data generating unit 111, a representative data selection unit 112, a crop characteristic prediction model generating unit 113, a crop characteristic prediction data generating unit 114, a crop characteristic prediction unit 115, and a crop characteristic prediction model evaluation unit 116 in the computer 100. The operations of the respective units 111 to 116 will be described later.

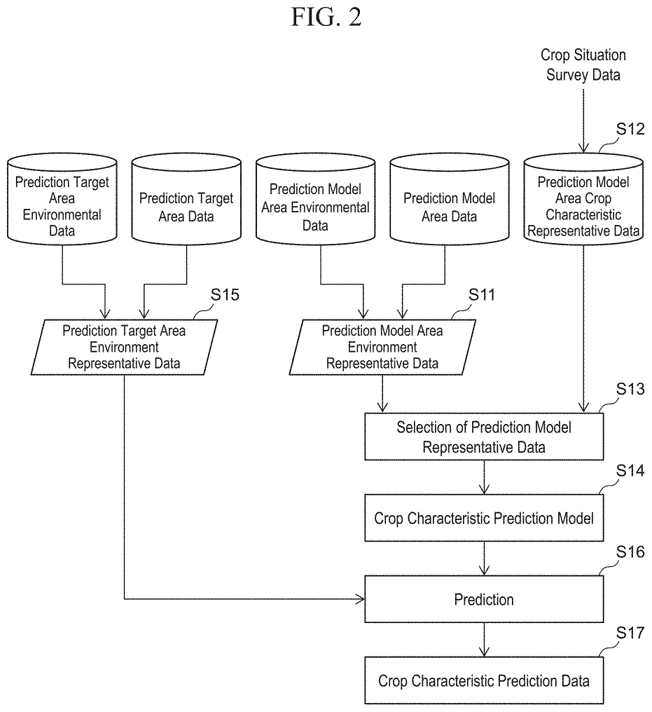

With reference to a flowchart of FIG. 2, an execution procedure of a crop characteristic prediction method executed in the system 1 will be described. This system 1 provides environmental data and crop characteristic data in an area (prediction model area) where a crop is actually cultivated and various data on the crop is aggregated as the agriculture-related big data. The crop characteristic prediction model generating unit 113 processes the data to generate the crop characteristic prediction model.

The crop characteristic prediction model is model data that is generated based on the crop characteristic data relating to a characteristic of the crop that is actually cultivated in the prediction model area to predict the characteristic of the crop in an area other than the prediction model area. Using the crop characteristic prediction model, the crop characteristic in the area (prediction target area) where the crop characteristic is desired to be predicted is predicted. The prediction result is output as crop characteristic prediction data. With this system, even without actually performing a harvesting or a cultivation test of a crop in a certain area (prediction target area), the crop characteristic can be predicted in accordance with the crop characteristic prediction model generated based on the cultivation result in another area (prediction model area). Since prediction in the prediction target area is carried out based on the characteristic data of the crop actually cultivated in the prediction model area as well as the prediction is carried out based on the data of the prediction model area that is in a similar environment, accurate prediction of the crop characteristic can be expected.

With reference to FIG. 2, an example of generation method of this crop characteristic prediction data will be described in detail. First, a procedure from Step S11 until a generation of the crop characteristic prediction model of Step 14 will be described.

First, the system 1 obtains the environmental data of the prediction model area and prediction model area data relating to a land and the like of the prediction model area via the communication control unit 107, aggregates these pieces of data in the representative data generating unit 111, and generates prediction model area environment representative data that representatively indicates the environment of the prediction model area (Step S11).

As one example, the prediction model area environmental data is soil data and weather data of the prediction model area, and includes geographic information system (GIS) data and AMeDAS data. Besides that, WAGRI data and the like is included. Additionally, as one example, the prediction model area data includes blank map data on the prediction model area.

The prediction model area environment representative data generated in Step S11 is generated by further selecting the soil data and the weather data of the prediction model area in accordance with a predetermined arithmetic operation rule and calculating soil area representative data and weather area representative data. One example of the arithmetic operation rule will be described later.

The prediction model area environment representative data can be generated by processing public data, such as the GIS data and the AMeDAS data. The GIS data and the AMeDAS data are mutually different in a data structure, and thus are processed in conformity to one unit of the prediction model area. Specifically, the soil area representative data can be generated by dividing data of respective cities, towns, and villages that correspond to the prediction model area into triangular shapes in the blank map data and calculating a proportion of the nature of the soil of the respective cities, towns, and villages based on the same number of pieces of the GIS data per area included in each of the triangular shapes. Since the same number of pieces of the GIS data per unit area is extracted, the soil data for the respective cities, towns, and villages can be uniformly extracted from the GIS data to make the soil area representative data.

Additionally, the weather area representative data is calculated as follows. First, data of the cities, towns, and villages on the blank map data are obtained to calculate barycentric positions of the respective cities, towns, and villages. Three points of observation points of the AMeDAS data are selected such that a triangular shape formed by connecting the three points includes the barycentric positions of the cities, towns, and villages inside. The weather area representative data of the respective cities, towns, and villages are generated from the weather data of the three points of the observation points (examples: a rainfall amount per day, an average temperature, a maximum temperature, a minimum temperature, an average wind speed, a maximum wind speed, a maximum instantaneous wind speed, hours of daylight, a snowfall amount, a maximum snowfall, and the like). Since the AMeDAS data is extracted and selected such that the triangular shape of the observation points internally including the barycentric positions of the respective cities, towns, and villages is formed, the weather data can be uniformly extracted from the AMeDAS data for the respective cities, towns, and villages to make the weather area representative data. Note that instead of dividing the area by the unit of cities, towns, and villages, the division can be carried out by a larger unit (such as prefectures, provinces, and regions) or by a smaller unit (such as communities and districts).

The prediction model area environment representative data is generated by aggregating the soil area representative data and the weather area representative data generated as described above.

On the other hand, the representative data generating unit 111 of the system 1 generates prediction model area crop characteristic representative data based on yield data per unit area (such as 10 years) of crop situation survey data of the respective cities, towns, and villages for past multiple years (such as 10 to 30 years) (Step S12). That is, the prediction model area crop characteristic representative data can be generated by further selecting the crop characteristic data aggregating the characteristic data (such as the yield) of the crop that has been actually cultivated in the prediction model area (Step S13). Note that instead of the yield data per unit area, the crop characteristic representative data may be generated from a planted area and the yield of the prediction model area.

Once the prediction model area environment representative data and the prediction model area crop characteristic representative data are obtained in Step S11 and S12, these pieces of data are aggregated to make prediction model area representative data. In the subsequent Step S13, the representative data selection unit 112 executes a data selection in accordance with a predetermined arithmetic operation rule on the prediction model area representative data. Note that an example of the arithmetic operation rule will be described later.

In Step S13, the prediction model area representative data is divided into a plurality of regions (here, two regions as a first region and a second region) in accordance with a predetermined rule before the data selection, and the data selection is carried out for each of the divided regions. The characteristics of crops significantly vary depending on climatic zones. In view of this, in the embodiment, the prediction model area representative data is divided into a plurality of regions and the data selection is executed for each of the divided regions. From the above-described viewpoint, the plurality of regions may be set in accordance with the climatic zones. Here, as one example, the first region is a region from 30.9 degrees to 41.5 degrees north latitude (mainly Honshu, Shikoku, and Kyushu), and the second region is a region of equal to or more than 41.5 degrees north latitude (mainly Hokkaido). However, this is one example, and the number of divisions and the division boundaries are not limited to these. Additionally, some crops, such as the crops having high resistance to climate difference, are not divided into a plurality of regions, and one piece of data can be made with the obtained whole region.

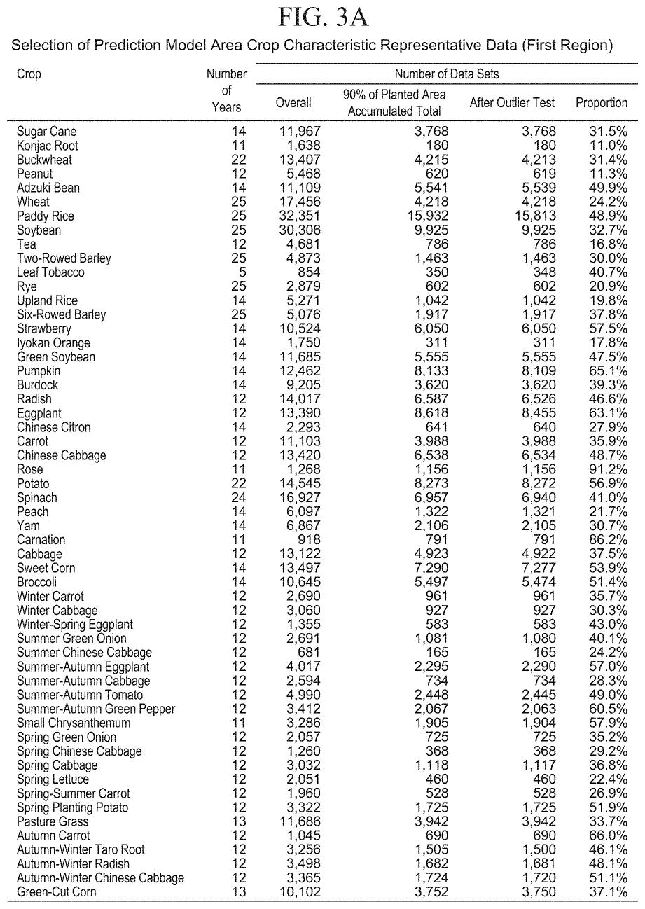

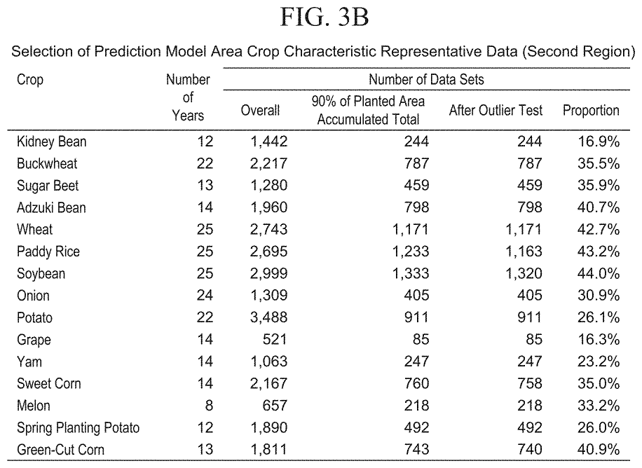

In the respective first region and second region, respective data of a plurality of kinds of crops and cropping types are selected as data in the prediction model area crop characteristic representative data. For example, as indicated in FIG. 3A and FIG. 3B, in the first region, data of 55 kinds of crops and cropping types can be selected, and in the second region, data of 15 kinds of crops and cropping types can be selected. However, this is also one example, and the kinds, the numbers, and the like of the crops and cropping types are not limited to these.

For each of the data of the plurality of crops and cropping types, all the data of the crops and cropping types included in the first region or the second region are not selected, but a part of the data is selected. As one example, after a total area of a planted area of a certain crop and cropping type in the first region is calculated, the planted area (by fiscal year) of the crop and cropping type in each of the cities, towns, and villages is added in descending order (in decreasing order) and continue to be added until its sum reaches 90% of the total area. The addition is completed at the point when 90% is exceeded to totalize as a numerical value of “90% of the planted area accumulated total.” The data of the crop and cropping type that are subject to the addition are selected as the data constituting the crop characteristic prediction model, and the data of the crop and cropping type that are not subject to the addition are excluded. In other words, the data pertaining to the accumulated total value that is accumulated up to 90% is selected as the data to generate the crop characteristic prediction model, and the remaining data is not subject to the selection. Note that here, the threshold is not limited to 90%, and it is needless to say that another value may be used. Additionally, in the example shown here, by accumulating in decreasing order of the planted areas, the data with small planted areas is excluded. However, conversely, it is possible to exclude the data in increasing order of the planted areas and to use only the remaining data. Basically, as long as the data pertaining to the small planted areas is excluded, a method does not matter.

For example, in FIG. 3A, the data on “sugar cane” is obtained in total of 11967 cities, towns, and villages inside the first region for the past 14 years. When the planted areas are added in order from a place having the largest value, and the planted areas of the “sugar cane” of the top 3768 cities, towns, and villages are added (accumulated), the accumulated total value reached 90% of the total area. That is, while the data of 31.5% in the data of the total of the 11967 cities, towns, and villages is subject to the accumulation, the data on the planted areas of the “sugar cane” of the remaining (68.5%) 8199 cities, towns, and villages are not selected to be excluded from the representative data. The data of the area having a large planted area is considered to have high universality and reliability compared with the data of the area having a small planted area. Adding in decreasing order of the planted areas and excluding the data of the areas having a small planted area can improve reliability in the crop characteristic prediction model.

Regarding other crops, a part of the data is selected, and the remaining data is excluded by the same method. The proportion of being selected differs according to the degree of variation of the planted areas of the crop in the respective cities, towns, and villages on the crop. When the variation is large, the proportion of selected data decreases. When the variation is small, the proportion increases.

In addition, an outlier test (Smirnov-Grubbs) is applied to the numerical value of 90% of the planted area accumulated total to select only the data included in a two-sided 95% of data distribution to exclude the data other than that and to output the selected data as the data after the outlier test. While the procedure of selecting the representative data in the first region has been described above, the procedure is the same for the second region (FIG. 3B). Thus, applying the outlier test can exclude the data on the crops obtained from special varieties and special cultivation methods. Excluding such data can generate the crop characteristic prediction model that is universally applicable to more prediction target areas. Note that while the threshold used in the outlier test is 5% here, it is needless to say that the threshold is not limited to this.

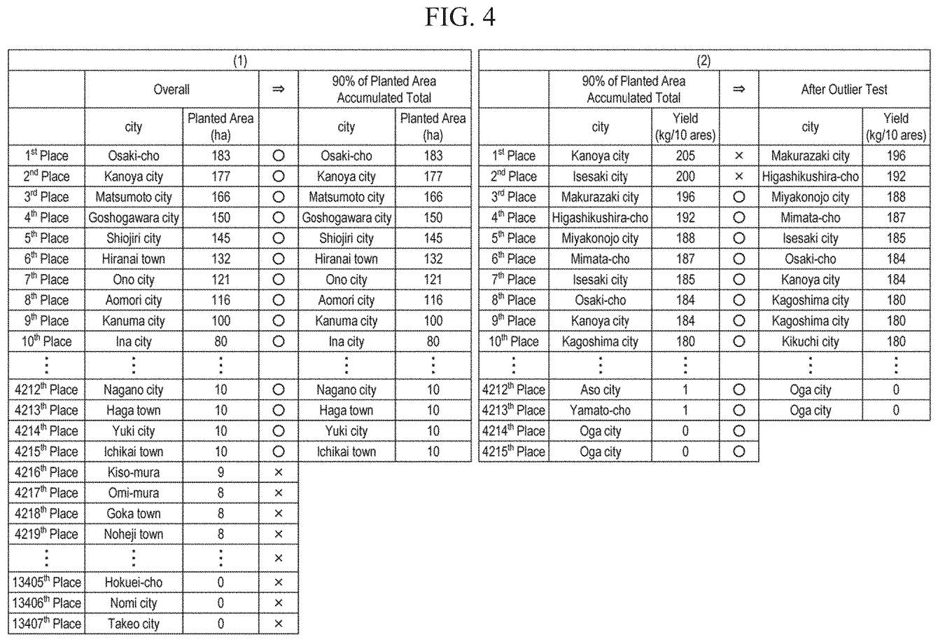

FIG. 4 indicates a procedure and a method of selecting prediction model representative data on a crop “buckwheat” in the first region. For the buckwheat, data on the planted areas of the total of 13407 cities, towns, and villages have been obtained in the first region for the past 22 years. After the total area of this 13407 planted areas is obtained, the accumulation is started from the data of the city, town, or village that has the largest planted area (Osaki town (Kagoshima prefecture)) and the accumulation is continued until 90% of the total area is reached. In this example, since 90% of the total area is reached when data of the 4215th Ichikai town (Tochigi prefecture) is added, the accumulation is canceled and data at and after 4216th is excluded from the selection.

Once the data of 90% of the planted area accumulated total is obtained, the outlier test is performed on a characteristic (yield) for the data on 90% of the planted area accumulated total as indicated on the right side in FIG. 4. The value after this outlier test is performed is the selected representative data.

Thus, in the embodiment, among many data sets of the planted area, only the data until the accumulated total of the planted areas reaches 90% of the total area is selected based on the planted area and the characteristic (yield) to make the representative data, and the data other than that is excluded. Reducing a data amount facilitates ensuring the data sets required to generate the prediction model, and generating and analyzing the data sets that indicate a general trend allows for generating the prediction model that can predict crop characteristics with high accuracy.

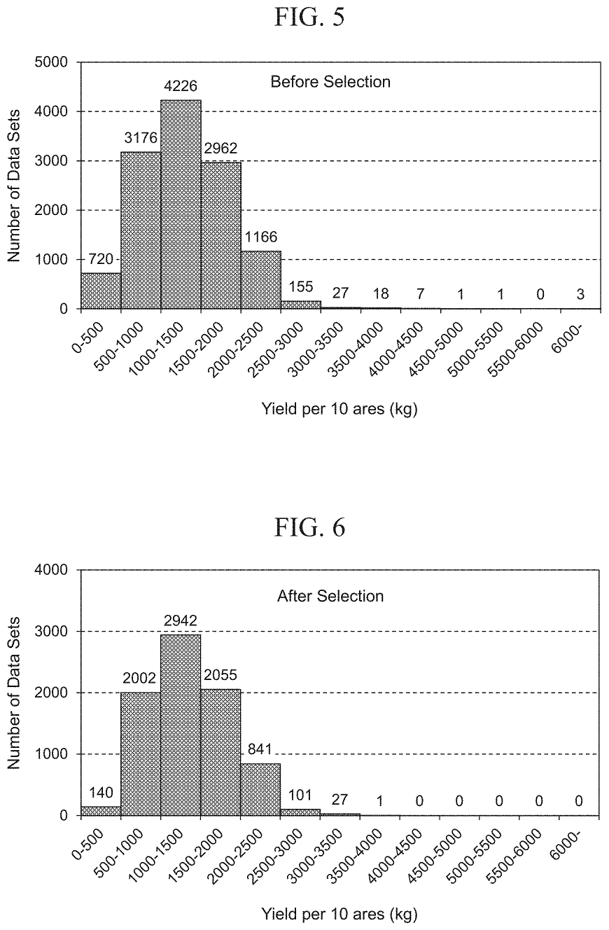

With reference to FIG. 5 to FIG. 8, in the embodiment, the effect of executing a selection of the representative data (Step S13) will be described. FIG. 5 and FIG. 6 indicate a change of the number of pieces of data on yield data per 10 years before and after the crop characteristic representative data on “pumpkin” is selected in the first region. As a result of the data selection on the pumpkin, the data equal to or more than 4000 kg/10 years is excluded.

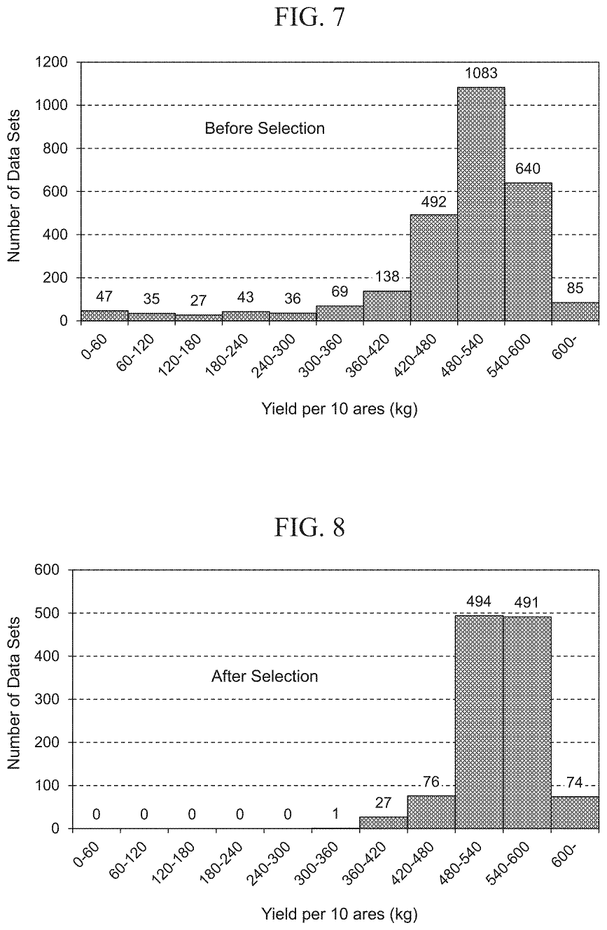

FIG. 7 and FIG. 8 indicate a change of the number of pieces of data on yield data per 10 years before and after the crop characteristic representative data on “paddy rice” is selected in the second region. As a result of the data selection on the paddy rice, the data equal to or less than 300 kg/10 years is excluded.

Back to FIG. 2, the description will be continued. When Step S13 ends, in the subsequent Step S14, based on the representative data thus selected, the crop characteristic prediction model is generated by the crop characteristic prediction model generating unit 113. When the prediction model representative data is divided into a plurality of regions (for example, two regions as the first region and the second region), the crop characteristic prediction model is also generated for each of the plurality of regions.

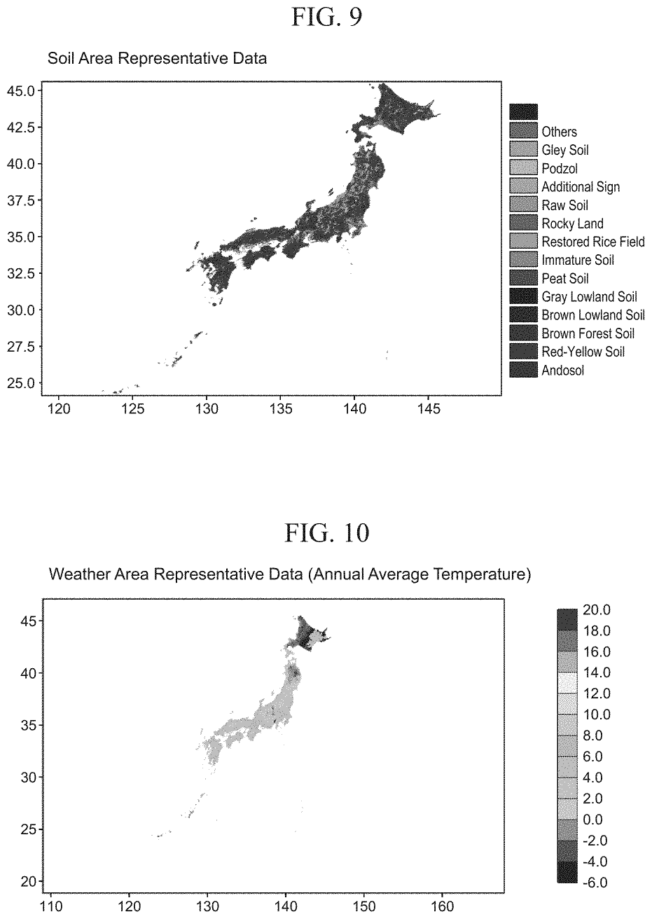

In Step S11, the soil area representative data and the weather area representative data of the prediction model area, for example, as illustrated in FIG. 9 and FIG. 10 as an example, are generated. In Step S14, these soil area representative data and weather area representative data are defined as explanatory functions, and the prediction model area crop characteristic representative data of each year is defined as an objective function to generate the crop characteristic prediction model by machine learning (Random Forest, GLMNET Lasso, PLS, and the like).

Meanwhile, for the prediction target area where the crop characteristic is desired to be predicted, based on environmental data of the prediction target area and prediction target area data including the blank map data and the like on the prediction target area, prediction target area environment representative data is generated (Step S15). A data structure of this prediction target area environment representative data may be approximately same as a data structure of the prediction model area environment representative data.

In Step S16, in the crop characteristic prediction unit 115, by applying the generated crop characteristic prediction model to the prediction model area environment representative data, the crop characteristic in the prediction target area is predicted, and its result is output as the crop characteristic prediction data by the crop characteristic prediction data generating unit 114 (Step S17).

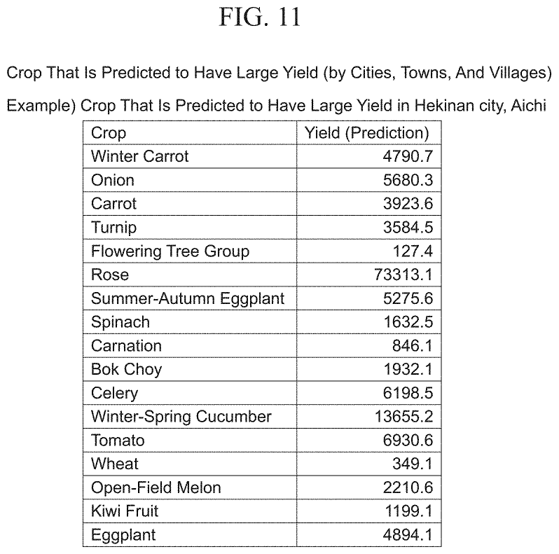

FIG. 11 indicates one example of the generated crop characteristic prediction data. In this FIG. 11, as one example, Hekinan city, Aichi prefecture is set as the prediction target area, and the prediction target area environment representative data on this Hekinan city is applied to the crop characteristic prediction model. For the prediction target area, soil area data and weather area data are input as the environmental data to define this as the prediction target area environment representative data. With reference to this prediction target area environment representative data, the crop characteristic prediction model lists the crops for which a large yield can be predicted in the prediction target area. In consideration of thus predicted result, the crops that are considered to be appropriate in the prediction target area can be selected, or a cropping area that are appropriate to the target crops can be selected.

Note that as one example of the crop characteristics, an example of predicting the yield has been described in the above-described example. However, an item to be a target of the prediction is not limited to the yield, and instead of the yield or in addition to this, various crop characteristics, such as a harvesting time, an operation timing, and the amount of growth, can be the targets of the prediction.

Thus, with the embodiment, even without actually performing the cultivation test in the target area where a characteristic, such as the crop yield, is desired to be predicted, using the crop characteristic prediction model obtained by obtaining and processing agriculture big data ensures collecting and analyzing the characteristic of the crop that can be harvested in the prediction target area in advance at low cost. In agricultural production, rotational cultivation and the like in which a plurality of crops are combined is performed, and its trend becomes more and more remarkable. Using the system of the embodiment allows for appropriately and reliably selecting the crops appropriate to a specific area and facilitates earnings estimates.

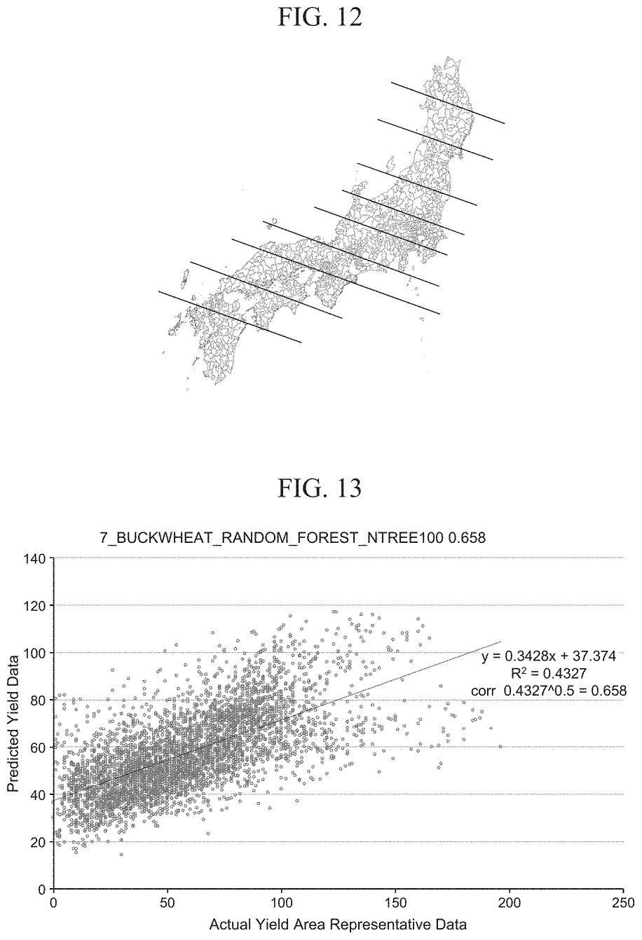

Note that the crop characteristic prediction model generated in Step S14 can be evaluated in the crop characteristic prediction model evaluation unit 116 to determine whether the crop characteristic prediction model satisfies predetermined criteria (such as, coefficient of correlation equal to or more than 0.5) or not. FIG. 12 and FIG. 13 are a conceptual diagram and a graph describing an exemplary evaluation method of the crop characteristic prediction model. First, the prediction model area environment representative data and the prediction model area crop characteristic representative data that are obtained are divided into a plurality of groups, for example, 10 groups, of data based on the blank map data (see FIG. 12). While in the example of FIG. 12, Honshu is divided into 10 along with straight lines inclined by 18 to 72° with respect to the meridian, the number of divisions and the division method are not limited to the example illustrated in the diagram.

Once each data is divided into 10 groups of data, a predetermined machine learning (for example, Random Forest, GLMNET Lasso, PLS, and the like) is applied to some of them, for example, nine groups of data sets to generate the crop characteristic prediction model for each of the nine groups. Using the nine crop characteristic prediction models, in accordance with the soil area representative data and the weather area representative data on the remaining one group of data set, the crop characteristic prediction data on this one group is generated. This crop characteristic prediction data is compared with data of an actual crop yield in the area of the one group by a regression analysis (see FIG. 13). As long as a coefficient of correlation between both is, for example, equal to or more than 0.5, the crop characteristic prediction model can be determined to be excellent. By executing the above-described operation on all the groups, the generated crop characteristic prediction model can be evaluated whether or not to be appropriate.

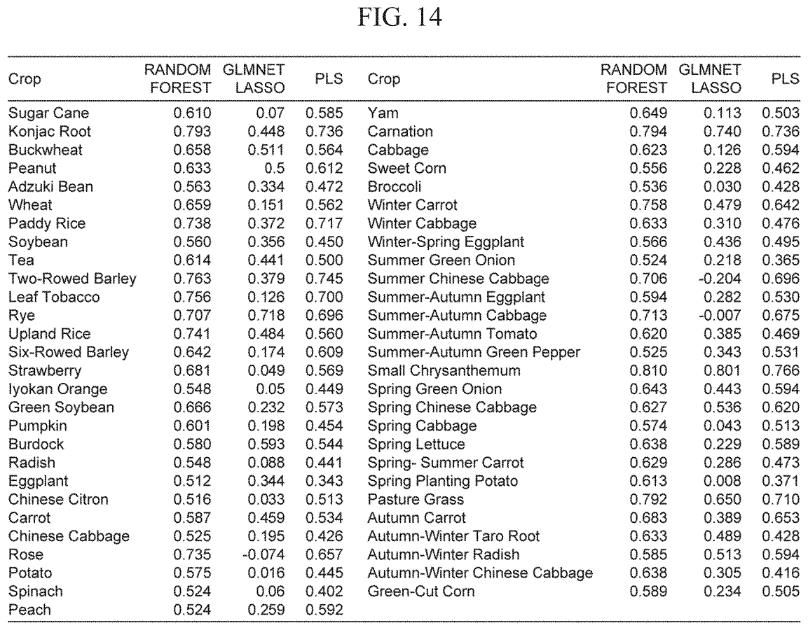

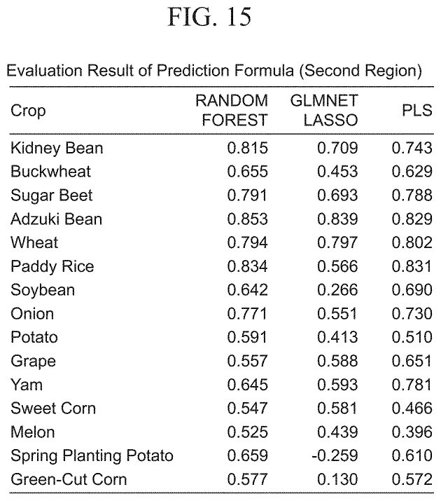

FIG. 14 indicates a result of evaluating the crop characteristic prediction model for each of the 55 kinds of crops and cropping types in the first region. FIG. 15 indicates a result of evaluating the crop characteristic prediction model for each of the 15 kinds of crops and cropping types in the second region. As evaluation methods, three of Random Forest, GLMNET Lasso, and PLS are used. In this example, the coefficient of correlation of the prediction model by Random Forest is a minimum of 0.512, a maximum of 0.810, and an average of 0.633, which are excellent results. Additionally, the coefficient of correlation of the prediction model by GLMNET Lasso is a minimum of −0.024, a maximum of 0.801, and an average of 0.290, which indicates that the average coefficient of correlation is low compared with that by Random Forest. However, for some of the crops and cropping types, high coefficient of correlation is obtained. The coefficient of correlation of the prediction model by PLS is a minimum of −0.259, a maximum of 0.839, and an average of 0.551, which are overall excellent. While the coefficient of correlation for some of the crops and cropping types is low, high coefficient of correlation is obtained for many of the crops and cropping types. In the second region, as indicated in FIG. 15, mostly the same results are obtained.

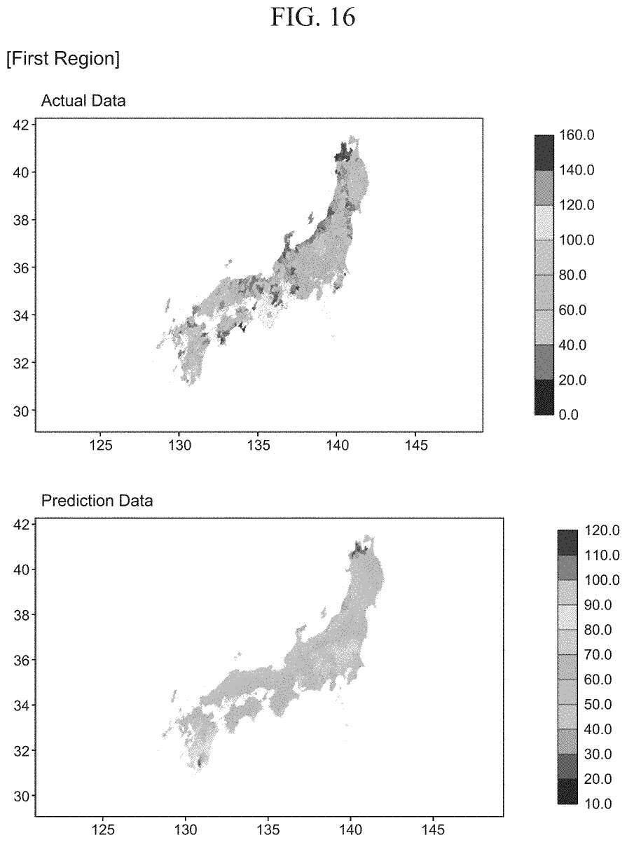

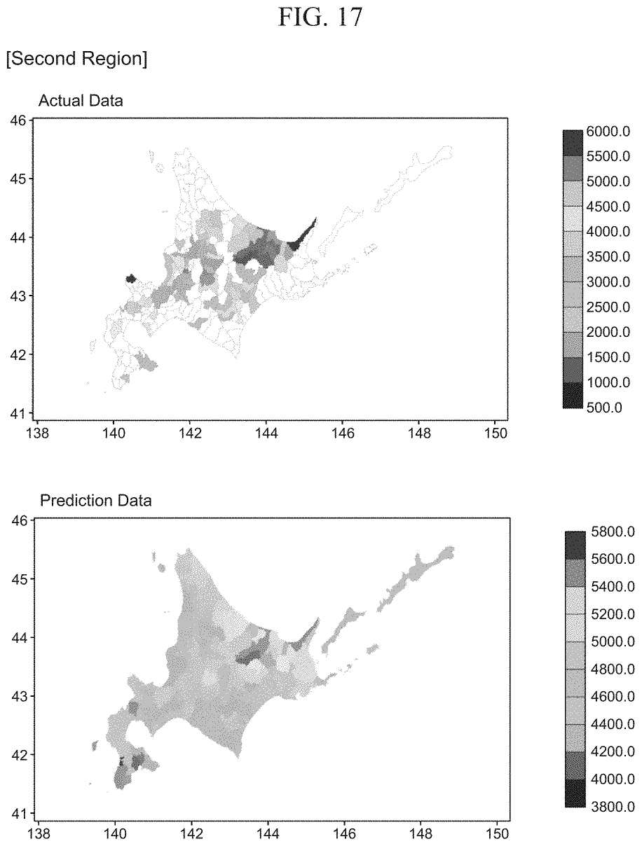

FIG. 16 and FIG. 17 contrastingly indicate actual crop characteristic data and the crop characteristic prediction data obtained by the system according to the embodiment in the first region and the second region, respectively. For both the first region and the second region, the crop characteristic prediction data obtained by this system is similar to the data based on the actually-cultivated crops, which indicates that the prediction of this system is accurate.

The present disclosure is not limited to the above-described embodiment and includes various modifications. For example, the above-described embodiment is explained in detail for easy understanding of the description of the present disclosure, and does not necessarily include all the explained configurations. A part of the configuration of one embodiment can be replaced by the configuration of another embodiment, and the configuration of one embodiment can be used with the addition of the configuration of another embodiment. Additionally, for a part of the configurations in the respective embodiments, another configuration can be added, deleted, or replaced.

### DESCRIPTION OF SYMBOLS

1 Crop characteristic prediction system
100 Computer
101 CPU
102 Input unit
103 Interface (I/F)
104 Display control unit
105 RAM
106 ROM
107 Communication control unit
108 Hard disk drive (HDD)
111 Representative data generating unit
112 Representative data selection unit
113 Crop characteristic prediction model generating unit
114 Crop characteristic prediction data generating unit
115 Crop characteristic prediction unit
116 Crop characteristic prediction model evaluation unit
200 Display
NW Network

What is claimed is:

1. A crop characteristic prediction system configured as a computer system, comprising:
a data input unit;
a data storage unit;
an arithmetic operation unit;
a representative data generating unit that generates prediction model area environment representative data that representatively indicates an environment of a prediction model area as an area where data relating to an actually-cultivated crop is obtained based on prediction model area environmental data relating to the environment of the prediction model area and prediction model area data relating to a land of the prediction model area, and generates prediction model area crop characteristic representative data that represents a crop characteristic as a characteristic of a crop cultivated in the prediction model area;
a crop characteristic prediction model generating unit that generates a crop characteristic prediction model based on the prediction model area environment representative data and the prediction model area crop characteristic representative data; and
a crop characteristic prediction data generating unit that generates prediction target area environment representative data that representatively indicates an environment of a prediction target area as an area where a crop characteristic of a crop to be a target is desired to be predicted based on prediction target area environmental data relating to the environment of the prediction target area and prediction target area data relating to a land of the prediction target area, and generates crop characteristic prediction data that indicates a crop characteristic of a crop in the prediction target area by applying the crop characteristic prediction model to the prediction target area environment representative data.

2. The crop characteristic prediction system according to claim 1,
wherein the crop characteristic prediction model generating unit selects data that constitutes the prediction model area crop characteristic representative data based on a planted area and the characteristic, and subsequently generates the crop characteristic prediction model in accordance with the selected data.

3. The crop characteristic prediction system according to claim 2,
wherein the crop characteristic prediction model generating unit selects data relating to a predetermined crop that constitutes the prediction model area crop characteristic representative data in decreasing order of the planted areas, and selects the data until an accumulated total value of the planted areas pertaining to the selected data exceeds a predetermined value.

4. The crop characteristic prediction system according to claim 3,
wherein the crop characteristic prediction model generating unit executes an outlier test on a characteristic of the selected data to further exclude a part of the selected data.

5. The crop characteristic prediction system according to claim 1,
wherein the crop characteristic prediction model generating unit divides the prediction model area crop characteristic representative data for each of a plurality of regions to generate the crop characteristic prediction model for each of the plurality of regions.

6. A crop characteristic prediction method using a computer system including a data input unit, a data storage unit, and an arithmetic operation unit, the method comprising:
generating prediction model area environment representative data that representatively indicates an environment of a prediction model area as an area where data relating to an actually-cultivated crop is obtained based on prediction model area environmental data relating to the environment of the prediction model area and prediction model area data relating to a land of the prediction model area;
generating prediction model area crop characteristic representative data that represents a crop characteristic as a characteristic of a crop cultivated in the prediction model area;
generating a crop characteristic prediction model based on the prediction model area environment representative data and the prediction model area crop characteristic representative data;
generating prediction target area environment representative data that representatively indicates an environment of a prediction target area as an area where a crop characteristic of a crop to be a target is desired to be predicted based on prediction target area environmental data relating to the environment of the prediction target area and prediction target area data relating to a land of the prediction target area; and
generating crop characteristic prediction data that indicates a crop characteristic of a crop in the prediction target area by applying the crop characteristic prediction model to the prediction target area environment representative data.

7. The crop characteristic prediction method according to claim 6,
wherein the generating of the crop characteristic prediction model selects data that constitutes the prediction model area crop characteristic representative data based on a planted area, and subsequently generates the crop characteristic prediction model in accordance with the selected data.

8. The crop characteristic prediction method according to claim 7,
wherein the generating of the crop characteristic prediction model selects data relating to a predetermined crop that constitutes the prediction model area crop characteristic representative data in decreasing order of the planted areas, and selects the data until an accumulated total value of the planted areas pertaining to the selected data exceeds a predetermined value.

9. The crop characteristic prediction method according to claim 8,
wherein the generating of the crop characteristic prediction model executes an outlier test on the selected data to further exclude a part of the selected data.

10. The crop characteristic prediction method according to claim 6,
wherein the generating of the crop characteristic prediction model divides the prediction model area crop characteristic representative data for each of a plurality of regions to generate the crop characteristic prediction model for each of the plurality of regions.

11. A non-transitory computer-readable storage medium storing a crop characteristic prediction program, the crop characteristic prediction program causing a computer system to execute:
generating prediction model area environment representative data that representatively indicates an environment of a prediction model area as an area where data relating to an actually-cultivated crop is obtained based on prediction model area environmental data relating to the environment of the prediction model area and prediction model area data relating to a land of the prediction model area;
generating prediction model area crop characteristic representative data that represents a crop characteristic as a characteristic of a crop cultivated in the prediction model area;
generating a crop characteristic prediction model based on the prediction model area environment representative data and the prediction model area crop characteristic representative data;
generating prediction target area environment representative data that representatively indicates an environment of a prediction target area as an area where a crop characteristic of a crop to be a target is desired to be predicted based on prediction target area environmental data relating to the environment of the prediction target area and prediction target area data relating to a land of the prediction target area; and
generating crop characteristic prediction data that indicates a crop characteristic of a crop in the prediction target area by applying the crop characteristic prediction model to the prediction target area environment representative data.
